(19) United States
(12) Patent Application Publication
(10) Pub. No.: US 2021/0121803 A1
(43) Pub. Date: Apr. 29, 2021

(54) FILTER CORE WATER FLOW CHANNEL

(71) Applicants: Xiaoping CHEN, Guangdong (CN); FOSHAN VIOMI ELECTRICAL TECHNOLOGY CO., LTD., Guangdong (CN)

(72) Inventor: Xiaoping CHEN, Guangdong (CN)

(21) Appl. No.: 16/616,991

(22) PCT Filed: May 24, 2018
(86) PCT No.: PCT/CN2018/088209

§ 371 Date: Nov. 26, 2019

(30) Foreign Application Priority Data
May 27, 2017 (CN) 201720608875.9

(51) Int. Cl. B01D 36/02; B01D 29/33; B01D 29/58; B01D 61/14; B01D 39/20

(52) U.S. Cl. CPC B01D 36/02; B01D 29/333; B01D 2311/2649; B01D 61/145; B01D 39/2055; B01D 29/58

(57) ABSTRACT

Disclosed is a filter core water flow channel, comprising a filter core housing (1), the filter core housing (1) respectively comprising an upper area (1) and a lower area (12) in mutual communication according to high to low positions, the upper area (11) being provided with a front filter core (2), the lower area (12) being provided with a kernel filter core (3), the filter core housing (1) further being provided with a water inlet (5) and a water outlet (6), the water inlet (5) being in communication with the upper area (11) via the lower area (12) around the kernel filter core (3), water passing through the water inlet (5) and the lower area (12) surrounding the kernel filter core (3) and entering the upper area (11), and after filtering by the front filter core (2), water then flowing into the kernel filter core (3), and finally flowing out via the water outlet (6).

### BACKGROUND OF THE INVENTION

The present invention relates to a filter element of water filtration, in particular to a filter element water flow passage.

A filter element in the prior art has various structures and styles. However, a water flow passage of a single filter element still has the following deficiencies: (1) due to a single structure of the conventional filter element, water generally flows into one end of the water flow passage and flows out from the other end thereof. That is, since water flow is almost horizontal and straight, a rate of the water flow is faster, and a filtering effect is poor. Further, since the water flows into one end and flows out the opposite end, a water intake and a water outtake of the filter element are connected, and the directions are different, which not only causes the overall volume to be too large, but also limits the application of the filter element to a certain extent.

### BRIEF SUMMARY OF THE INVENTION

The object of the present invention is to overcome the deficiencies of the prior art described above, and to provide a filter element water flow passage with a simple and reasonable structure, which significantly extends a water flow passage in the same unit volume, is beneficial to improving a filtering effect, and is applicable to a wide range of aisle.

The object of the present invention is achieved in this way:

A filter element water flow passage comprises a filter element housing, where the filter element housing includes an upper region and a lower region respectively according to high position and lower positions; the upper region and the lower region are communicated to each other, the upper region is provided with a prepositive filter element; the lower region is provided with a core filter element; the housing is provided thereon with a water inlet and a water outlet; the water inlet is in communication with the upper region via the lower region around the core filter element, and the water outlet is in communication with the core filter element. Water enters the upper region via the water inlet and the lower region at an outer periphery of the core filter element, is filtered by the prepositive filter element, flows into the core filter element, and finally flows out from the water outlet. For the filter element water flow passage, water enters the upper region from the water inlet via a periphery of the core filter element of the lower region, enters the prepositive filter element via a periphery of the prepositive filter element, then flows into the lower region at the lower portion thereof, is filtered by the core filter element, and finally flows out from the water outlet. The water flow passage actually forms a flow path of water flow flowing from bottom to top and then from top to bottom in the filter element housing, which obviously extends the water flow passage in the same unit volume; a flow direction of the water flow passage is changed; the flow rate is slowed, which is beneficial to improve the filtration effect of the water flow. Moreover, due to the change of the flow direction of the water flow, the positions of the water inlet and the water outlet of the filter element can be unrestricted and can be at the same side or different sides, which has diverse and flexible installation, a wider range of applications and a simple and reasonable structure.

The object of the present invention can also be achieved by the following technical measures:

Further, the water inlet and the water outlet are both arranged at the bottom of the filter housing; that is, the positions of the water inlet and the water outlet are arranged on the same side, which obviously extends the filter element passage.

Further, the prepositive filter element comprises at least two filter materials, and an inner layer core and an outer layer core that are arranged at inner and outer positions. The outer layer core is wrapped on the outer wall of the hollow inner layer core. Water enters an inner cavity of the inner layer core via an outer side wall of the outer layer core, and then flows down into the core filter element of the lower region. Since water enters through the periphery of the prepositive filter element, which has a large water inlet area and is favorable for rapid water intake.

Further, a central water outlet pipe is further comprised and comprises an upper end inlet and a lower end outlet. The upper end inlet extends into the middle or upper portion of an inner cavity of the hollow inner layer core, and the lower end outlet is inserted into the core filter element. Therefore, water is rushed upward from the periphery of the prepositive filter element at an outer periphery of the bottom. Since gas is generally at the upper portion thereof, the gas is rushed to the central water outlet pipe by the water, is discharged from the central water outlet pipe, and does not stay in the top of the filter element (the inner cavity of the prepositive filter element). There is no waste of the top of the filter element (the prepositive filter element), and the water can pass through a filter material of the entire filter element (the prepositive filter element).

Further, in the inner cavity of the inner layer core, there is a gap between an outer wall of the central water outlet pipe and an inner wall of an inner cavity of the inner layer core. Thus, water from the periphery of the prepositive filter element can flow quickly to the central water outlet pipe of the inner cavity of the inner layer cavity; that is, a water inlet area of the central water outlet pipe relatively large, which is advantageous for rapid water intake.

Further, there is a gap between an inner wall of an upper portion of the filter element housing and an outer wall of the prepositive filter element, so that the water is rushed upward from the bottom of the prepositive filter element, and may pass through the periphery of the entire prepositive filter element.

Further, a center vertical line of the water inlet and a center vertical line of the water outlet are parallel to each other such that the inflow and outflow directions of the water are parallel to each other.

Further, the prepositive filter element is hollow and cylindrical and comprises a PP folded outer layer core, to have an inner layer core of a hollow carbon rod composite filter element wrapped in the PP folded outer layer core. The water enters and is filtered via an outer side wall of the PP folded outer layer core and an outer side wall of an inner layer core of the hollow carbon rod composite filter element, and then flows down out via an inner cavity of the inner layer core of the hollow carbon rod composite filter element.

Further, the top of the hollow cylindrical prepositive filter element is provided with a top cover of the prepositive filter element, and the bottom thereof is placed on an extension platform of the central water outlet pipe. The lower end of the central water outlet pipe is inserted into the core filter element. The bottom of the the core filter element is placed on an ultrafiltration lower cover. The ultrafiltration lower cover is provided with an outlet, and the outlet is connected to the water outlet at the bottom of the filter element housing, so that the water flowing through the inner cavity of the prepositive filter element passes through the central water outlet pipe, the core filter element, and the ultra-filtration lower cover successively and finally flows out from the water outlet at the bottom of the filter element housing.

Further, the core filter element is an ultrafiltration UF. There is a gap between the ultrafiltration UF and the bottom of the ultrafiltration lower cover to form a certain water storage interval on the ultrafiltration lower cover to ensure a sufficient and stable flow rate.

The beneficial effects of the present invention are as follows:

(1) For the filter element water flow passage, water enters the upper region from the water inlet via a periphery of the core filter element of the lower region, enters the prepositive filter element via a periphery of the prepositive filter element, then flows into the lower region at the lower portion thereof, is filtered by the core filter element, and finally flows out from the water outlet. The water flow passage actually forms a flow path of water flow flowing from bottom to top and then from top to bottom in the filter element housing, which obviously extends the water flow passage in the same unit volume: a flow direction of the water flow passage is changed; the flow rate is slowed, which is beneficial to improve the filtration effect of the water flow. Moreover, due to the change of the flow direction of the water flow, the positions of the water inlet and the water outlet of the filter element can be unrestricted and can be at the same side or different sides, which has diverse and flexible installation, a wider range of applications and a simple and reasonable structure.

(2) Further, since the center outlet pipe is further comprised. Therefore, water is rushed upward from the periphery of the prepositive filter element at an outer periphery of the bottom. Since gas is generally at the upper portion thereof, the gas is rushed to the central water outlet pipe by the water, is discharged from the central water outlet pipe, and does not stay in the top of the filter element (the inner cavity of the prepositive filter element). There is no waste of the top of the filter element (the prepositive filter element), and the water can pass through a filter material of the entire filter element (the prepositive filter element).

(3) In addition, the water coming from the periphery of the prepositive filter element can quickly flow to the central water outlet pipe of the inner cavity of the inner layer cavity, that is, the water inlet area of the central water outlet pipe is relatively large, which is favorable for rapid water intake.

### BRIEF DESCRIPTION OF THE DRAWINGS

FIG. 1 is a view of a water flow passage of a filter element according to the present invention.

FIG. 2 is a view of the disassembly of a filter element of the present invention.

### DETAILED DESCRIPTION OF THE INVENTION

The present invention will be further described below in conjunction with the accompanying drawings and embodiments:

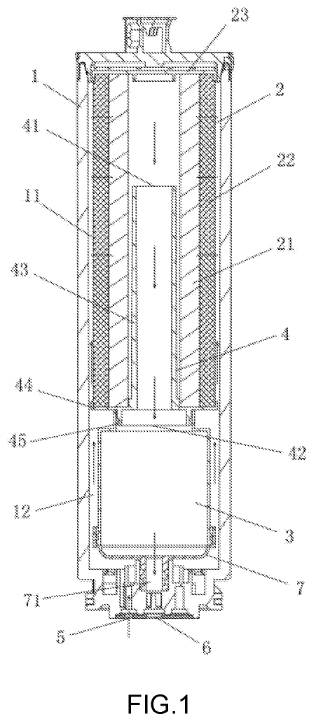

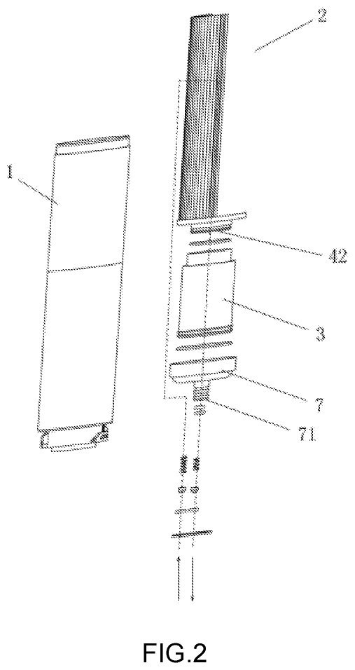

Referring to FIGS. 1 and 2, a filter element water flow passage comprises a filter element housing 1, the filter element housing 1 comprises an upper region 11 and a lower region 12 according to high and lower positions, respectively. The upper region 11 and the lower region 12 are in communication with each other, The upper region 11 is provided with a prepositive filter element 2. The lower region 12 is provided with a core filter element 3. The filter element housing 1 is further provided with a water inlet 5 and a water outlet 6. The water inlet 5 is in communication with the upper region 11 via the lower region 12 at a periphery of the core filter element 3. The water outlet 6 is in communication with the core filter element 3. Water enters the upper region 11 via the water inlet 5 and the lower region 12 at an outer periphery of the core filter element 3, is filtered by a prepositive filter element 2, flows into the core filter element 3, and finally flows out from the water outlet 6. The water inlet 5 and the water outlet 6 are both arranged at the bottom of the filter element housing 1.

In this embodiment, the prepositive filter element 2 comprises at least two filter materials, and an inner layer core 21 and an outer layer core 22 that are arranged at inner and outer positions. The outer layer core 22 is wrapped in an outer wall of a hollow inner layer core. Water enters an inner cavity of the inner layer core 21 via an outer side wall of an outer layer core 22 and flows down into the core filter element 3 of the lower region 12.

In this embodiment, a central water outlet pipe 4 is further comprised, and comprises an upper end inlet 41 and a lower end outlet 42. The upper end inlet 41 extends into the middle or upper portion of the inner cavity of the hollow inner layer core 21. The lower end outlet 42 is inserted into the core filter element 3. In the inner cavity of the inner layer core 21, there is a gap between an outer wall of the central water outlet pipe 4 and an inner wall of an inner cavity of the inner layer core.

As a more specific embodiment, there is a gap between the inner wall of the upper region 11 of the filter element housing 1 and the outer wall of the prepositive filter element 2. The center vertical line of the water inlet 5 and the center vertical line of the water outlet 6 are parallel to each other.

The prepositive filter element 2 is hollow and cylindrical and comprises a PP folded outer layer core 22, to have an inner layer core 21 of a hollow carbon rod composite filter element wrapped in a PP folded outer layer core 22. Water enters and is filtered by successively an outer side wall of the PP folded outer layer core 22 and an outer side wall of the inner layer core 21 of the hollow carbon rod composite filter element, and then flows down out via the inner cavity of the inner layer core 21 of the hollow carbon rod composite filter element.

The top of the hollow cylindrical prepositive filter 2 is provided with a top cover 23 of a prepositive filter element, and the bottom thereof is placed on an extension platform 44 of the central water outlet pipe 4. The lower end of the central water outlet pipe 4 is inserted into the core filter element 3. The bottom of the core filter element 3 is placed on an ultrafiltration lower cover 7. The ultrafiltration lower cover 7 is provided with an outlet 71. The outlet 71 is connected to the water outlet 6 at the bottom of the filter element housing 1 so that water flowing down via the inner cavity of the prepositive filter element 2 passes through the central water outlet pipe 4, the core filter element 3 and the ultrafiltration lower cover 7 successively, and finally flows out from the water outlet 6 at the bottom of the filter element housing 1. The core filter element is an ultrafiltration UF. There is a gap between the ultrafiltration UF and the ultrafiltration lower cover 7.

Working principle: water enters from the water inlet 5 at the bottom of the filter housing 1, is rushed upwards along the lower region 12 at a periphery of the core filter element 3, enters the upper region 11 a periphery of the prepositive filter element 2, enters the inner layer core 21 via an outer side wall of the outer layer core 22 of the prepositive filter element 2, is performed with initial filtration, flows down into the core filter element 3 via the central water outlet pipe 4 for secondary filtration, and is finally discharged from the water outlet 6 via an outlet of the ultrafiltration lower cover.

1. A filter element water flow passage, comprising a filter element housing (1), wherein the filter element housing (1) comprises an upper region (11) and a lower region (12) according to high position and lower positions, respectively, the upper region (11) and the lower region (12) are communicated to each other, the upper region (11) is provided with a prepositive filter element (2), the lower region (12) is provided with a core filter element (3), the filter element housing (1) is further provided thereon with a water inlet (5) and a water outlet (6), the water inlet (5) is in communication with the upper region (11) via the lower region (12) around the core filter element (3), the water outlet (6) is in communication with the core filter element (3), water enters the upper region (11) via the water inlet (5) and the lower region (12) at an outer periphery of the core filter element (3), is filtered by the prepositive filter element (2), flows into the core filter element (3), and finally flows out from the water outlet (6).

2. The filter element water flow passage according to claim 1, wherein the water inlet (5) and water outlet (6) are both arranged at the bottom of the filter element housing (1).

3. The filter element water flow passage according to claim 1, the prepositive filter element (2) comprises at least two filter materials, and an inner layer core (21) and an outer layer core (22) that are arranged according to inner and outer positions, the outer layer core (22) is wrapped around an outer wall of the hollow inner layer core (21), water enters an inner cavity of the inner layer core (21) from an outer side wall of the outer layer core (22), and then flows down into the core filter element (3) of the lower portion (12).

4. The filter element water flow passage according to claim 3, further comprising a central water outlet pipe (4), the central water outlet pipe (4) comprising an upper end inlet (41) and a lower end outlet (42), the upper end inlet (41)) extending into the middle or upper portion of an inner cavity of a hollow inner layer core (21), and the lower end outlet (42) being inserted into the core filter element (3).

5. The filter element water flow passage according to claim 3, wherein in the inner cavity of the inner layer core (21), there is a gap between an outer wall of the central water outlet pipe (4) and an inner wall of the inner layer core (21).

6. The filter element water flow passage according to claim 1, wherein there is a gap between an inner wall of the upper region (11) of the filter element housing (1) and an outer wall of the prepositive filter element (2).

7. The filter element water flow passage according to claim 2, wherein a central vertical line of the water inlet (5) and a central vertical line of the water outlet (6) are parallel to each other.

8. The filter element water flow passage according to claim 1, wherein the prepositive filter element (2) is hollow and cylindrical and comprises a PP folded outer layer core (22) to have the inner layer core (21) of a hollow carbon rod composite filter element wrapped in the PP folded outer layer core (22), water enters and is filtered by an outer side wall of the PP folded outer layer core (22) and an outer side wall of the inner layer core (21) of the hollow carbon rod composite filter element (21) successively, and then flows down out via the inner cavity of the inner layer core (21) of the hollow carbon rod composite filter element inner layer core (21).

9. The filter element water flow passage according to claim 8, wherein the top of the hollow cylindrical prepositive filter element (2) is provided with a prepositive filter element top cover (23), and the bottom thereof is placed on an extension platform (44) of the central water outlet pipe (4), an lower end of the central water outlet pipe (4) is inserted into the core filter element (3), the bottom of the core filter element (3) is placed on an ultrafiltration lower cover (7), the ultrafiltration lower cover (7) is provided with an outlet (71), the outlet (71) is connected to the water outlet (6) at the bottom of the filter element housing (1) so that water flowing down through the inner cavity of the prepositive filter element (2) passes through the central water outlet pipe (4) the core filter element (3) and the ultrafiltration lower cover (7) and finally flows out from the water outlet (6) at the bottom of the filter element housing (1).

10. The filter element water flow passage according to claim 9, wherein the core filter element (3) is an ultrafiltration UF, and there is a gap between the ultrafiltration UF and the bottom of the ultrafiltration lower cover (7).
